(19) United States
(12) Patent Application Publication
(10) Pub. No.: US 2008/0162506 A1
(43) Pub. Date: Jul. 3, 2008

(54) DEVICE AND METHOD FOR WORLD WIDE WEB ORGANIZATION

(76) Inventors: Janette W. Stephenson, Coral Springs, FL (US); Dwight Ham, Sunrise, FL (US)

Correspondence Address: MAYBACK & HOFFMAN, P.A., 5722 S. FLAMINGO ROAD #232, FORT LAUDERDALE, FL, 33330, US

(21) Appl. No.: 11/619,425

(22) Filed: Jan. 3, 2007

(51) Int. Cl. G06F 17/30

(52) U.S. Cl. 707/100; 707/E17.044

(57) ABSTRACT

A method and a device for organizing World Wide Web content includes defining a plurality of domain names with each domain name including a different unique category term and a prefix common to all the domain names. A plurality of subcategories is then associated with each unique category term, where each subcategory is related to the category term.

### FIELD OF THE INVENTION

This invention relates in general to internet content location and more specifically to a web organizer that clusters information through a scheme of domain name prefixes.

### BACKGROUND OF THE INVENTION

The Internet is a publicly accessible worldwide network of other interconnected computer networks. It consists of millions of smaller domestic, academic, business, and government networks, which together carry various information and services, such as electronic mail, online chat, file transfer, and the interlinked Web pages and other documents of the World Wide Web.

The Internet and the World Wide Web (Web) are not synonymous: the Internet is a collection of interconnected computer networks, linked by any communicative means, such as copper wires, fiber-optic cables, wireless connections, etc., while the Web is a collection of interconnected documents and other resources, linked by hyperlinks and Uniform Resource Locators (URLs). The Web is accessible via the Internet, as are many other services including e-mail, file sharing, and others described below.

The Web is accessed by navigating to any of a vast amount of “pages,” which are each located at a unique address. Each page is able to contain “content,” such as graphics, text, video, and sound. Programmers control what content appears on each page. In addition, each page is able to link to other pages through hyperlinks. These other pages are identified by URLs embedded in the hyperlink and contain further content. Due in part to the ease in Web page programming, the Web has experienced a steep exponential increase in the number of pages and the amount of content available via the Internet.

Compared to traditional sources, such as encyclopedias and libraries, the World Wide Web has enabled a rapid decentralization of information and data. “Search engines” are well known document retrieval systems used to locate information stored on the Web. Through keyword-driven Internet search engines, like Google, Yahoo, AskJeeves, and many others, millions worldwide have instant access to a vast and diverse amount of online information.

Known search engines work by accepting a user-input keyword or words with which it uses to perform a comparison to content on Web pages. The comparison can be a basic direct comparison, a complex algorithm, or somewhere in the middle. Once a specified number of pages are searched, the results are ranked in some order of relevance. A great deal work has been done in the field of relevancy determination. The results are then displayed in a list, with the determined most relevant page being at the top of the list and the least relevant at the bottom.

Unfortunately, determining relevancy is not an exact science. Many search engines define the most relevant site as a site where the keyword appears most frequently. However, the page where the keyword(s) appear the highest number of times is not always relevant to the use of the word the searcher is looking for. For instance, if a searcher is looking for a divorce attorney and enters the keywords “divorce attorney,” a site containing content that discusses a class for divorce attorneys might come up in the top three pages located. Additionally, the search can be location dependent. A page for a divorce attorney might be found, but the probability that he is located within driving distance of the searcher is slim. Even adding additional keywords to the search is not always effective, because a divorce attorney in California may have gone to school in Florida and the keyword “Florida” will generate an irrelevant site to a searcher in California that searches for “divorce attorney florida.”

There is currently no way for a searcher to know, out of a list of usually thousands of located Web pages, which page the searcher is seeking. Having to click on each of the non-strategically and inaccurately ranked Web pages located after a search, in order to determine which one is the most relevant, is tedious for the searcher and creates a great deal of frustration.

Therefore a need exists to overcome the problems with the prior art as discussed above.

### SUMMARY OF THE INVENTION

Embodiments of the present invention provide a method and a device for organizing World Wide Web content, which includes defining a plurality of domain names with each domain name including a different unique category term and a prefix common to all the domain names. A plurality of subcategories is associated with each unique category term, where each subcategory is related to the category term and at least one of the plurality of subcategories is presented in response to accessing one domain name within the plurality of domain names.

In accordance with another feature, an embodiment of the present invention includes determining at least a portion of an amount of content on at least one Web page and linking the at least one Web page to at least one of the plurality of subcategories based on the at least a portion of the amount of content.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a distributed data processing system in which the present invention may be implemented.

FIG. 2 is a block diagram illustrating an exemplary computing system that can be used as or in conjunction with the server device of FIG. 1 or the client device of FIG. 1, according to an embodiment of the present invention;

FIG. 3 is a screen shot of an exemplary Web browser that can be used with embodiments of the present invention;

FIG. 4 is an exemplary screen shot of a Web browser displaying a Web page that includes a topic list, according to an embodiment of the present invention;

FIG. 5 is an exemplary screen shot of a Web browser displaying a further Web page that includes a topic list, according to an embodiment of the present invention; and

FIG. 6 is a flow diagram illustrating horizontal organization of web searching and results drill-down, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Embodiments of the present invention provide a World Wide Web (Web) organizer that clusters information within relevant categories that are intuitive and locatable to a searcher through a system providing a plurality of domain names each having a consistent prefix that is common to all of the domain names and each having a different unique search subject appended to the prefix. The present invention allows a searcher to narrow down her search in a logical way that is faster, more efficient, and most importantly, produces much more accurate results than any currently-known search method.

Network

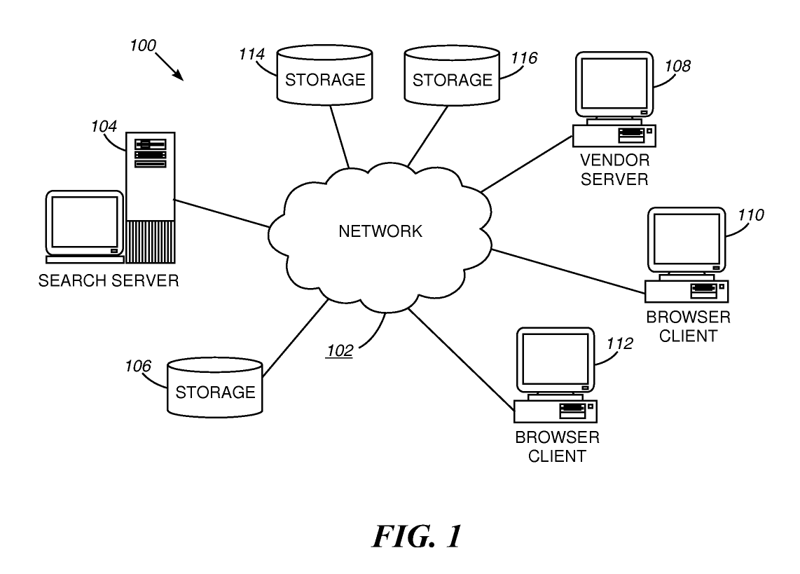

With reference now to the figures, FIG. 1 depicts a pictorial representation of a network of data processing devices in which the present invention may be implemented. Network data processing system 100 contains a network 102, which is the medium used to provide communications links between various devices and computers connected together within network data processing system 100. The network 102 may include wired or wireless connections. A few exemplary wired connections between nodes and/or communications devices include cable, phone line, and fiber optic. Exemplary wireless connections include radio frequency (RF) and infrared radiation (IR) transmission. Many other wired and wireless connections are known in the art and can be used with the present invention.

In the depicted example, a search server 104 is connected to network 102 along with storage units 106, 114, and 116 that store data and are accessible to the search server 104 via the network 102. In addition, a vendor server 108 and browser clients 110 and 112 also are connected to network 102. The vendor server 108 and clients 110 and 112 may be, for example, personal computers or network computers. In the depicted example, the clients 110 and 112 are clients to search server 104 and vendor server 108. The servers provide data such as graphic and multimedia files, information, boot files, operating system images, applications and others to clients 110 and 112. Clients 110 and 112 and the servers 104 and 108 can each be executing the same or a different operating system. Storage units 106, 114, and 116 may be all be coupled directly to one of the servers 104, 108 or to one of the browser clients 110, 112, or any combination thereof.

Network data processing system 100 may include additional servers, clients, and other devices not shown. In the depicted example, network data processing system 100 includes the Internet with network 102 representing a worldwide collection of networks and gateways. The vendor server 108 is a server that pertains to and is at least partially involved in presenting a webpage connected to a particular vendor. The vendor server 108 is accessible to the browser clients 110 and 112, as well as to the search server 104, that is also accessible to the browser clients 110 and 112.

Network Communication

The devices connected by the Internet communicate and transmit data by packet switching using protocols. In this context, there are three layers of protocols. At the lowest level is the Internet Protocol (IP), which defines the datagrams or packets that carry blocks of data from one node to another. Next are the Transmission Control Protocol (TCP) and User Datagram Protocol (UDP)—the protocols by which one host sends data to another. TCP creates a virtual “connection,” which gives some level of guarantee of reliability. UDP is a best-effort, connectionless transport, in which data packets that are lost in transit will not be re-sent.

At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Once a networking structure is established using IP and TCP, then other protocols are able to run “on top.” These other protocols are sometimes called “services” or “applications.” These protocols define the specific messages and data formats sent and understood by the applications running at each end of the communication. Hypertext transfer protocol (HTTP) is an application layer protocol that links billions of files together over the Web. These files are located by their unique internet IP addresses.

The internet functions by utilizing a globally-unified namespace (i.e., a system of names in which there is only a single holder of each name). The Internet Corporation for Assigned Names and Numbers (ICANN) is the authority that coordinates the assignment of unique identifiers on the Internet, including domain names, Internet protocol addresses, and protocol port and parameter numbers.

The domain name system (DNS) stores and associates many types of information with domain names, but most importantly, it translates domain names (computer hostnames) to IP addresses. The DNS makes it possible to attach easy-to-remember domain names (such as “pepsi.com”) to hard-to-remember IP addresses (such as 55.134.200.100).

A Website is a compilation of information on the Web, usually segmented into Web pages, and can be accessed through a Web browser. This information is usually in HTML or XHTML format, and may provide navigation to other Web pages via hypertext links. Web pages are requested and served from Web servers using HTTP and can be “static” or “dynamic.” Static Web pages include files of static text within the Web server's file system. With dynamic Web pages, the Web server reads files of computer code that instruct it how to construct the (X)HTML for each web page when it is requested by a browser.

Static web pages usually have the filename extension .htm or .html. Server-side dynamic web pages usually reflect the language or technology used at the server, such as PHP, JavaServer Pages, or many others, taking associate URL/filename extensions (.php or .jsp).

Almost all Web pages include instructions defining background colors, text size, font, and color, and other properties. In addition, Web pages often include links to images and other media, such as sound or video files, to be included in the final rendering of the page. Images are stored on the web server as separate files, however, HTTP allows associated files such as images and stylesheets to be requested when the Webpage is downloaded and processed at the browser. Games, animations, and other computer-generated material can also be embedded using technologies such as Adobe Flash and Java applets.

Web Page Organization

Embodiments of the present invention analyze Web pages to discern the content associated with the page. The invention is not limited to any particular type or format of content that can be analyzed or methods of analysis. The invention is also not limited to any number of Webpages involved in an analysis or the method of determining order or types of pages to analyze.

Once the pages are analyzed and at least a portion of the content is determined, the page is placed into one or more categories, or topics, based on one or more of the pieces of content. Embodiments of the present invention are then able to create further subcategories within each general category and organize Web pages and their content into these further subcategories.

The categories are not limited and can include any word, phrase, character, or character combination. For example, a Web page that contains text describing the shoes worn by an athlete competing in the Olympics can be placed in the topics of “shoes,” “footwear,” “sports,” “clothing,” “Olympics,” “running,” etc. A second page containing prices of shoes would also be under the general shoe topic, as well as others. And still another page having a picture entitled “shoe” would fall under the topic of shoe, as well as others. However, as should be obvious, these three exemplary pages are distinct from one another in content and a user looking for one, would probably not be interested in the others. For instance, a user looking to purchase shoes probably would not care what Michael Johnson wore in the last summer Olympics as those shoes are not for sale to the public and would not function for many uses other than running short-distance track events. Additionally, the probability that the picture entitled “shoe” is the same shoe the person is seeking or the one that Michael Johnson wore in the last summer Olympics is very low.

In addition, categories can include pictures, music, or any other media content based upon the type of data present on the web page. For instance, programs can exist that are able to dissect content, such as pictures or music files to determine the content of the file, such as the subject of a picture or recording. These programs allow pictures, video, and audio, with otherwise meaningless or misleading titles or descriptions to be categorized in accordance with embodiments of the present invention.

According to one embodiment of the present invention, each topic or category is able to be divided, or broken down, into subcategories. For example, the category of “shoes” can be subdivided into the subcategories of “articles about shoes,” “shoe sellers,” “shoe information,” “photos of shoes,” and many others. The general “shoe” category or any of the subcategories can also be subdivided by location-based criteria. As an example, the present invention may locate hundreds or even thousands of pages referencing shoes for sale. Many of the pages, as most do, may also have location data identifying a location of the shoe seller operating or advertising on the site.

According to one embodiment of the present invention, by clicking on or otherwise selecting one of the subcategories, a new page, or entry area, is displayed that provides location-narrowing choices to a user. These choices can be country, state, city, zip code, and others. Pages having location information and matching the general category term, in this case “shoe,” can be filtered down based on the user's selection of the location range. Location-based narrowing is very effective for locating a vendor or source or subject of the content that is within driving range of the user. Sophisticated analysis of Web pages ensures that the vendor is located at a specific location and the location is not simply a word appearing on the Webpage for a reason unrelated to the vendor's true location. Location determination of vendors can be, for instance, by searching for the vendor's actual address within the page through algorithms that filter erroneous or misleading addresses. For instance, the address must be within x characters or lines of the vendor's name.

In one embodiment of the present invention, instead of navigating to a subsequent page to enter or otherwise provide location-narrowing data, the searcher can be presented location-narrowing choices on the first page presented after the searcher enters the subject as part of the domain name. For instance, a clickable map or zip code entry box may be presented. After selecting or entering location data, a subsequent page can then be presented that pertains to that location selection.

Physical geography can be defined by metropolitan service area (MSA). MSAs can be tailored after the “metropolitan statistical areas” defined by the U.S. government for geographical areas within the U.S. and can continue to be refined as the government refines, designates, or restructures metropolitan statistical area definitions. Any method of determining geographic information related to a Web page or source of information appearing on, or in connection with, a Web page is within the spirit and scope of the present invention.

As an example of the advantages of accurately extracting and strategically utilizing geographic information, as is accomplished with the present invention, consider the following example. With the prior-art search engines, a user might enter “refrigerator” and “Florida” as search criteria. Obviously, a refrigerator is not an object that one would want to have to ship from California if a nearby vendor can supply it and deliver it. However, an actual search using these words as search terms in a popular search engine turned up as the first listed Website, a site that sells refrigerators, but has no apparent connection to Florida. In fact, a search for the word “Florida” on the page showed that “Florida” did not appear on the page at all. A page with the description “Refrigerator Magnets, in all types and sciences, Florida birds pictures . . . ” was the second listed entry. The third listed site had a description “ . . . . Refrigerator Repair. We supply coils to dealers in Alabama, Florida . . . ” As should be apparent, none of the top three listed sites are what the searcher is looking for. However, if all of these sites were grouped into the category “refrigerator,” with the subcategories “parts,” “repairs,” “new sales,” “information,” “reviews,” etc., the searcher could quickly filter out the irrelevant sites. By selecting “new sales,” the searcher could then be taken to a new page where the sites offering refrigerators for sale are displayed. These sites can be further subdivided by location data contained on their pages. The above examples are provided for discussion purposes only and the present invention is not limited to any category, set of categories, or category-determination method.

To provide easy location of Websites or subcategories of pages or information pertaining to a particular topic, embodiments of the present invention provide a plurality of domain names that each have a consistent and common prefix with a topic or category term appended to the prefix. For example, in accordance with an embodiment of the present invention, a multitude of sites are registered and created with the prefix “find.” Users, through any means possible, become aware of the prefix and know that when searching for a topic, they can simply type into their Web browser “find” plus the topic. For example, when searching for refrigerators, a searcher only needs to enter into her browser “findrefrigerator.com.” The domain name findrefrigerator.com is registered and corresponds to a specific IP address. At that address, according to an embodiment of the present invention, is a page having and presenting to a searcher a plurality of subcategories associated with refrigerators, as discussed above. It should be noted that the present invention is not limited to any specific top-level domain, such as .com, .net, .tv, and the like, and can operate with one, several, or any number of TLDs.

Therefore, instead of presenting to a user a long list that includes irrelevant Web sites, the searcher is presented multiple subcategories from which to choose. These subcategories allow the searcher to quickly narrow down the results of their search without having to open each found page to manually determine relevance, as is necessary with the prior art.

As a clear example of the advantages of the present invention, we refer again to the search for a refrigerator in Florida using a conventional search engine. Both the terms “refrigerator” and “florida” were entered into the conventional search engine and to determine if any of the pages were vendors of refrigerators located in Florida, it was necessary to read the short excerpt from each page retrieved by the search engine (provided the engine has that feature) or open each page to actually view its contents. As described above, after performing an actual search, and opening three pages, the proper site still was not located. There is no way of determining how many further pages would need to be opened before the proper site would be found.

In contrast, by utilizing an embodiment of the present invention, a searcher would type into the browser's navigation bar, the consistent prefix along with the search topic “refrigerator.” For example, “findrefrigerator.com.” A page residing at that IP address will be presented. The page will present to the user a list of subcategories, with one subcategory being “New refrigerators for Sale.” Other subcategories could be “Refrigerator Parts,” “Refrigerator Repairs,” “Refrigerator Accessories,” and many others. According to one embodiment, the subcategory “New Refrigerators for Sale” is a selectable hyperlink to another page that is associated with located third-party content, i.e., pages, that have new refrigerators for sale. The invention can lead the searcher directly to an advertiser's page, or may present a further page that includes sub-subcategories, such as a sub-category defined by a geographic location of a vendor with a link labeled “location.” The location sub-subcategory can provide a dropdown menu, a zip code entry field, a location entry field, or a hyperlink to further pages. In other embodiments, the page residing at the IP address that corresponds to the entered domain name, in this example “findrefrigerator.com,” can display a clickable map so that a searcher can immediately drill down to results narrowed by location. In other embodiments, a text box may be provided allowing a searcher to type their location search criteria. All known sites that sell new refrigerators and have a location identifier can be associated with location-selection choices. Therefore, according to an embodiment of the present invention, at least one of the subcategories appearing on the displayed results page is defined by a location of entities associated with the search results associated with the respective subcategory. The term “entities” as used herein refers to persons, businesses, groups, locations, such as states or cities, and the like.

The pages reside in memory and are accessible with server equipment computing devices and prompted to access the pages by remote computing devices or by the server itself.

Computing Devices

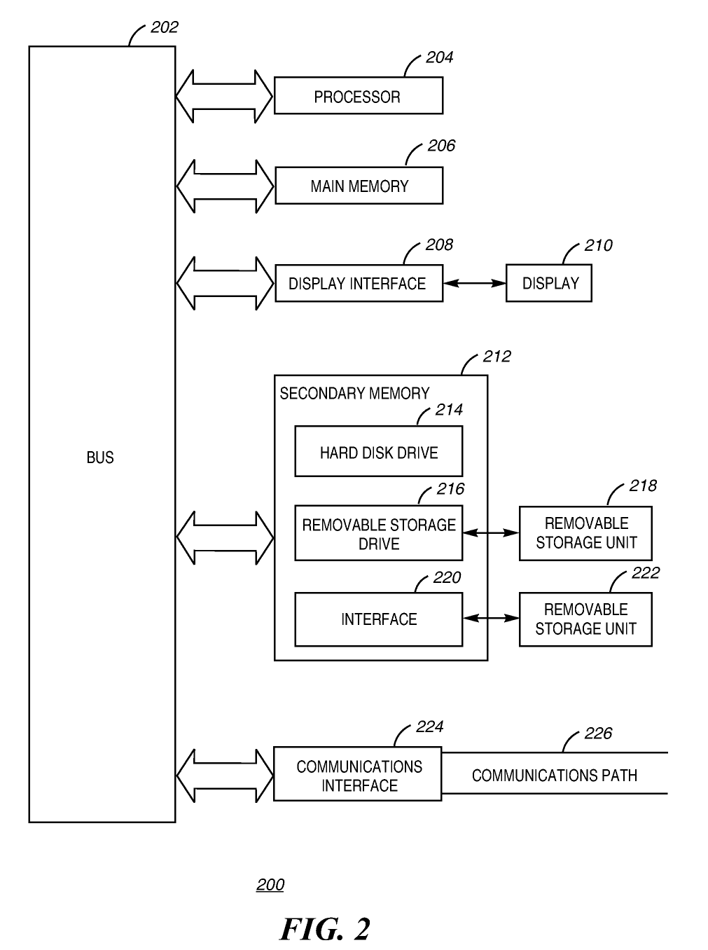

Referring to FIG. 2, a block diagram of a data processing system that may be implemented as a server, such as server 104 or 108 in FIG. 1, or as a client device 110 or 112 of FIG. 1, is depicted in accordance with one embodiment of the present invention. In one embodiment of the present invention, the computer system 200 includes one or more processors, such as processor 204. The processor 204 is connected to a communication infrastructure 202 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system 200 can include a display interface 208 that forwards graphics, text, and other data from the communication infrastructure 202 (or from a frame buffer) for display on the display unit 210. The computer system also includes a main memory 206, preferably random access memory (RAM), and may also include a secondary memory 212 having components such as a hard disk drive 214 and/or a removable storage drive 216 representing a floppy disk drive, a magnetic tape drive, an optical disk drive, etc. The removable storage drive 216 reads from and/or writes to a removable storage unit 218 in a manner well known to those having ordinary skill in the art. Removable storage unit 218, represents a floppy disk, a compact disc, magnetic tape, optical disk, etc. which is read by and written to by removable storage drive 216. As will be appreciated by one of ordinary skill in the art, the removable storage unit 218 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 212 may include other similar means for allowing computer programs or other instructions to be loaded into the computer system as commonly known in the art. Such means may include, for example, a removable storage unit 222 and an interface 220. Examples of such may include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to the computer system.

The computer system, in this example, includes a communications interface 224 that allows software and data to be transferred between the computer system and external devices via a communications path 226. Examples of communications interface 224 may include a modem, a network interface (such as an Ethernet card), a communications port, a PCMCIA slot and card, etc. Software and data transferred via communications interface 224 are in the form of signals which may be, for example, electronic, electromagnetic, optical, or other signals capable of being received by communications interface 224. The signals are provided to communications interface 224 via a communications path (i.e., channel) 226. The channel 226 carries signals and may be implemented using wire or cable, fiber optics, a phone line, a cellular phone link, an RF link, and/or other communications channels. Data stored in any of the data storage areas 206, 212 of the computer system 300 can be inventoried.

In this document, the terms “computer program medium,” “computer usable medium,” and “computer readable medium” are used to generally refer to media such as main memory 206 and secondary memory 212, removable storage drive 216, a hard disk installed in hard disk drive 214, and signals. The computer program products are means for providing software to the computer system. The computer readable medium allows the computer system to read data, instructions, messages or message packets, and other computer readable information from the computer readable medium.

Computer programs (also called computer control logic) are stored in main memory 206 and/or secondary memory 212. Computer programs may also be received via communications interface 224. Such computer programs, when executed, enable the computer system to perform the features of the present invention as discussed herein. In particular, the computer programs, when executed, enable the processor 204 to perform the features of the computer system. Accordingly, such computer programs represent controllers of the computer system.

An operating system runs on processor 204 and is used to coordinate and provide control of various components within data processing system 200 in FIG. 2. Each client is able to execute a different operating system. The operating system may be a commercially available operating system, such as Windows XP, which is available from Microsoft Corporation. A database program such as Oracle may run in conjunction with the operating system and provide calls to the operating system from Java programs or applications executing on data processing system 200. “Oracle” is a trademark of Oracle, Inc. and “Java” is a trademark of Sun Microsystems, Inc. Instructions for the operating system, the object-oriented operating system, and applications or programs are located on storage devices, such as hard disk drive 214, and may be loaded into main memory 206 for execution by processor 204.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

As another example, computer system 200 may be a stand-alone system configured to be bootable without relying on some type of network communication interface, whether or not computer system 200 comprises some type of network communication interface. As a further example, data processing system 200 may be a Personal Digital Assistant (PDA) device, which is configured with ROM and/or flash ROM in order to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

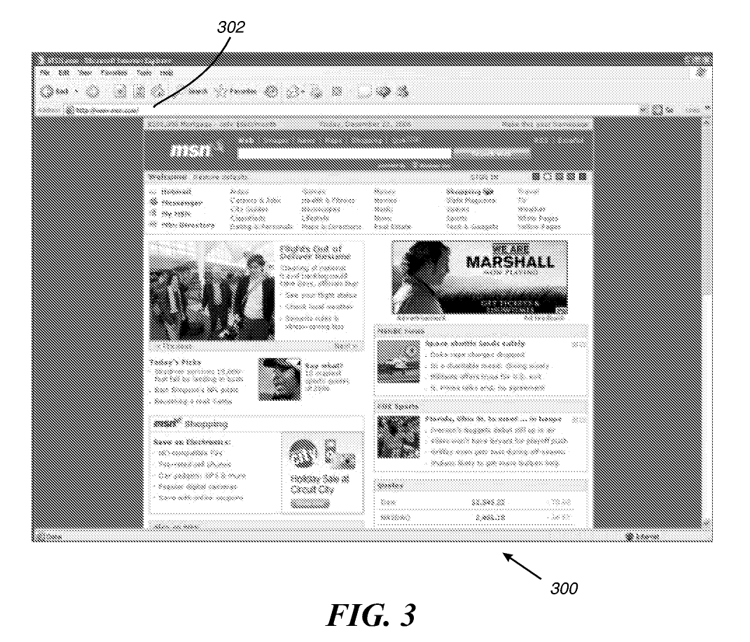

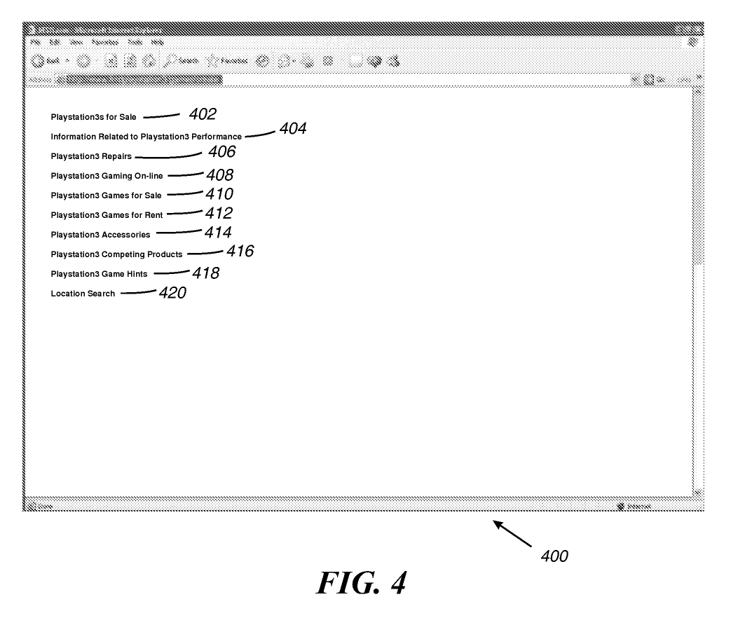

FIGS. 3-5 show a graphic example of an exemplary search performed by one embodiment of the present invention. FIG. 3 is a screen capture of a typical internet browser 300. The browser 300 has a navigation field 302 that accepts URLs or IP address entries. The navigation field 302 has the URL “findplaystation3.com” as an entry, where “find” is the prefix used for this example and “playstation3” is the item being searched for. After hitting the “enter” key, the browser navigates to the page residing at the IP address www.findplaystation3.com, an example of which is shown in FIG. 4.

Because there are so many subjects someone typing in the topic of “playstation3” might be interested in, the present invention provides a quick way to navigate to the subject area they are looking for. FIG. 4 is merely one example of what a page for the topic of playstation3 would include. The page 400 includes a plurality of selectable hyperlinks 402-420 including “Playstation3s for Sale” 402, formation Related to Playstation3 Performance” 404, Playstation3 Repairs” 406, “Playstation3 Gaming On-line”408, “Playstation3 Games for Sale” 410, “Playstation3 Games for Rent” 412, “Playstation3 Accessories” 414, “Playstation3 Competing Products” 416, “Playstation3 Game Hints” 418, and “Location Search” 420. In addition to performing as a general hyperlink, the choices 402-420 can provide additional features, such as roll-over text or graphical previews, annotations, sounds, and others that further help a searcher select the proper choice.

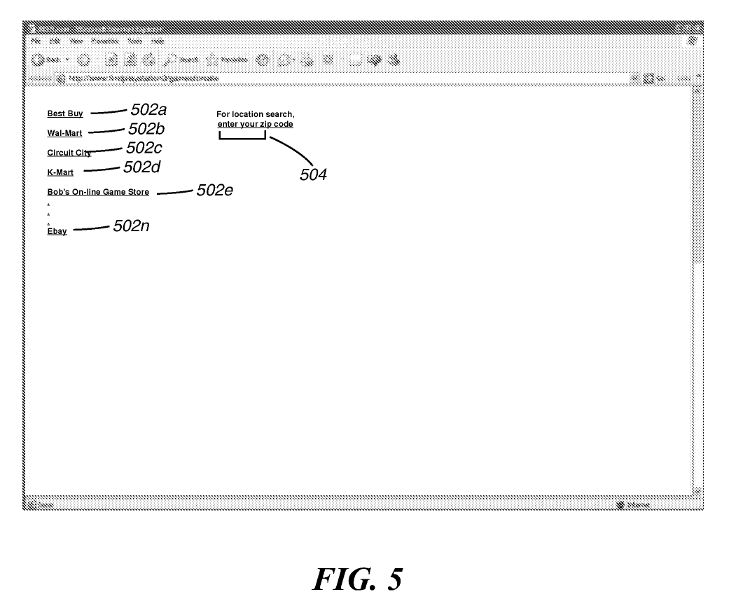

FIG. 5 shows an example of what a page may look like resulting from a user selecting hyperlink 410 in page 400. Page 500 provides links to further narrow down the searcher's results. Page 500 includes links to sites or other content, such as video or music, that relate to new Playstation3 games for sale. In the particular example shown in FIG. 5, links 502-502n are provided that connect directly to multiple vendors' Web sites. There is also a location search field 504, where a searcher can enter a zip code of interest. In other embodiments, a map can appear on the page giving a searcher the ability to click on the location to which they wish to narrow the search. In still another embodiment, an input box is provided where a searcher can type the name of the location. The invention can then narrow down the hyperlinks 502a-502n displayed to the user. This can occur dynamically on the page or the searcher may be directed to a further page that contains search results displayed based on their location-based content.

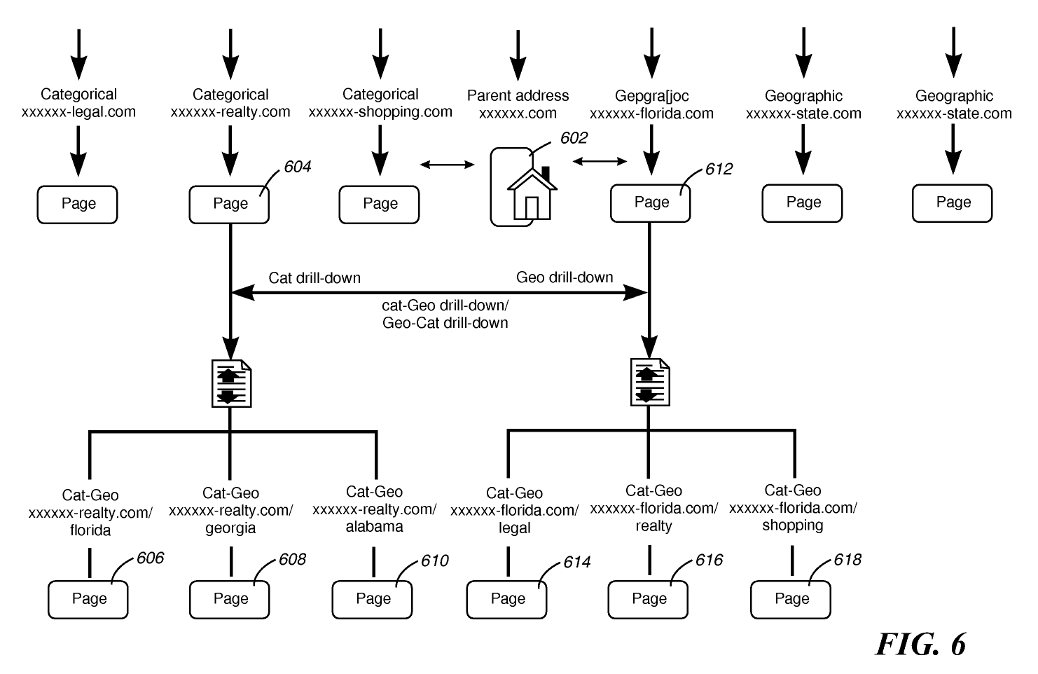

FIG. 6 illustrates the “horizontal” nature of embodiments of the present invention. At the top of the figure are several exemplary domain names that include a prefix (represented as xxxxxx, which is associated with the search service, as described above) as well as a search category, separated from the prefix by a dash, although the separation is not necessary and other characters can be used by various embodiments. The three domain names on the left of FIG. 6 are categorical subjects and are labeled “Categorical” for reference. The three domain names on the right of FIG. 6 include geographic subjects and are labeled “Geographic” for reference. Entering any of these domain names will result in the presentation of a page, which is represented directly below each domain name example.

In the upper center of FIG. 6 is a parent address, which allows a searcher to enter a parent page 602 residing at an IP address corresponding to a domain name simply including the prefix and a top level domain, in this example “.com”. On the parent page 602, choices are available to a searcher, such as categories, user entry forms, or other ways of entering a subject. The parent page then sends the searcher to one of the pages that was originally locatable by entering the prefix and search topic.

Once a page is presented to a searcher, the searcher can “drill down” to further narrow their search. As indicated in FIG. 6, drilling down, in one embodiment, can be by category or by geography. Narrowing of results can also be performed by both category and geography. For instance, as shown in FIG. 6, an initial search for the topic realty resulted in the a page 604 being presented. The searcher can then narrow his search by location. At the bottom of FIG. 6, the initial domain name xxxxxx (representing a specific prefix) -realty.com is appended with geographic identifiers to become example addresses xxxxxx-realty.com/florida, xxxxxx-realty.com/georgia, xxxxxx-realty.com/alabama, which lead to pages 606, 608, and 610, respectively. In another example, a search that was originally initiated by using a location topic, xxxxxx-florida.com, leads to page 612. This search is then shown in FIG. 6 to be further narrowed by the searcher making categorical selections on page 612 that lead to three example pages 614, 616, and 618 located at IP addresses corresponding to domain names xxxxxx-florida.com/legal, xxxxxx-florida.com/realty, xxxxxx-florida.com/shopping.

It should be clear that the invention is not limited to presenting any particular result types or categories, but that the overall presentation is, in a sense, horizontal rather than a vertical list of ranked results, as is the result of prior art search engines. In other words, instead of traveling down a list of sites presented to a user based on their sequential relevancy rankings, embodiments of the present invention allow a searcher to travel “horizontally” over to a classification of search results to instantly locate sites that might otherwise be buried in the vertical list of the prior art. A user performing a search no longer needs to navigate to a single search engine page, but can now intuitively navigate directly to a topic page by being aware of and utilizing the consistent prefix.

In one embodiment of the present invention, if the searcher enters the prefix but then incorrectly spells a search term, or enters a search term that is not registered or recognized, a page is displayed to the searcher that guides the searcher in selecting a better search entry. The page can offer a list of related terms, request the searcher re-enter his search term, make a best-guess approximation of what the searcher is looking for and present a page accordingly, or any other possibility.

One embodiment of the present invention provides a character, symbol, or combination thereof, such as a dash, between the prefix and the search term. The character helps make the URL more readable for the searcher. For instance, find-refrigerator.com is easier to read and detect spelling errors than the address findrefrigerator.com.

The present invention is advantageous in that it makes it easy to add new topics and/or geo-relevant data at any time, as well as expand or restrict the depth and breadth of any topic, simply by altering the content of any page. The invention allows Internet users to enter the search results produced by some embodiments of the present invention at any point, since the structure's platform is “horizontal,” meaning that, as opposed to presenting results in an ordered list, the results are present in a plurality of categories without regard to a hierarchy. The traditional hierarchical ranking of sites is therefore circumnavigated. Entry into the invention is as simple as thinking of a topic and typing it after the distinct and designated domain name prefix. The invention is also advantageous in that it supports Top Level Domain (TLD) placement (i.e., it sits at the top level of the Internet and is the first entry onto the Internet) and is therefore long-lived and impervious to technology advances from one generation to the next, including domain name URL or HTML advances/changing. Embodiments of the invention also provide the added advantage of topical organization of links to secure databases that are inaccessible to by traditional engine crawlers (e.g., U.S. Securities and Exchange Commission, registration or payment required databases—the “invisible web”). The invention is also able to provide links to individual/company/organization blogs or future embodiments of any web page.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for organizing World Wide Web content, the method comprising:
defining a plurality of domain names with each domain name including a different unique category term and a prefix common to all the domain names;
associating a plurality of subcategories with each unique category term, where each subcategory is related to the category term; and
presenting at least one of the plurality of subcategories in response to accessing one domain name within the plurality of domain names.

2. The method according to claim 1, wherein:
the presenting at least one of the subcategories comprises presenting a web page located by the domain name that includes the unique category term associated with the at least one of the subcategories.

3. The method according to claim 1, further comprising:
determining at least a portion of an amount of content on at least one Web page; and
linking the at least one Web page to at least one of the plurality of subcategories based on the at least a portion of the amount of content.

4. The method according to claim 1, wherein the prefix and the category term are separated by at least one character.

5. The method according to claim 1, wherein at least one of the subcategories is defined by a location of entities associated with results associated with the respective subcategory.

6. The method according to claim 1, wherein at least one of the subcategories is presented with a respective link to a Web page with sub-subcategories associated with the at least one of the subcategories.

7. A device for organizing World Wide Web content, the device comprising:
a memory; and
a processor communicatively coupled to the memory, the processor for:
defining a plurality of domain names with each domain name including a different unique category term and a prefix common to all the domain names;
associating a plurality of subcategories with each unique category term, where each subcategory is related to the category term; and
storing the associations in the memory.

8. The device according to claim 7, further comprising:
an output for outputting a web page located by the domain name that includes the category term associated with the at least one of the subcategories, where at least one of the subcategories is presented as part of the web page.

9. The device according to claim 7, further comprising:
an input for receiving content associated with at least one Web page, wherein the processor determines at least a portion of an amount of content on the at least one Web page and links the at least one Web page to at least one of the plurality of subcategories based on the at least a portion of the amount of content.

10. The device according to claim 7, wherein the prefix and the category term are separated by at least one character.

11. The device according to claim 7, wherein at least one of the subcategories is defined by a location of entities associated with results associated with the respective subcategory.

12. The device according to claim 7, wherein at least one of the subcategories is presented with a respective link to a Web page with sub-subcategories associated with the at least one of the subcategories.

13. A computer program product for organizing World Wide Web content, the computer program product comprising:
a storage medium readable by a processing circuit and storing instructions for execution by the processing circuit for performing a method comprising:
defining a plurality of domain names with each domain name including a different unique category term and a prefix common to all the domain names;
associating a plurality of subcategories with each unique category term, where each subcategory is related to the category term; and
presenting at least one of the plurality of subcategories in response to accessing one domain name within the plurality of domain names.

14. The computer program product according to claim 13, wherein:
the presenting at least one of the subcategories comprises presenting a web page located by the domain name that includes the unique category term associated with the at least one of the subcategories.

15. The computer program product according to claim 13, further comprising:
determining at least a portion of an amount of content on at least one Web page; and
linking the at least one Web page to at least one of the plurality of subcategories based on the at least a portion of the amount of content.

16. The computer program product according to claim 13, wherein the prefix and the category term are separated by at least one character.

17. The computer program product according to claim 13, wherein at least one of the subcategories is defined by a location of entities associated with results associated with the respective subcategory.

18. The computer program product according to claim 13, wherein at least one of the subcategories includes a link to a Web page with sub-subcategories associated with the at least one of the subcategories.
